(19) United States
(12) Patent Application Publication
(10) Pub. No.: US 2026/0111710 A1
(43) Pub. Date: Apr. 23, 2026

(54) AUTO-REGRESSIVE OUTPUT GENERATION WITH RELATIVE POSITION CROSS-ATTENTION

(71) Applicant: Google LLC, Mountain View, CA (US)

(72) Inventors: Eric Dean Battenberg, Walnut Creek, CA (US); Russell John Wyatt Skerry-Ryan, Mountain View, CA (US); Daisy Stanton, San Francisco, CA (US); Soroosh Mariooryad, Los Altos, CA (US); Sean Matthew Shannon, San Francisco, CA (US); David Teh-Hwa Kao, Philadelphia, PA (US); Julian Emilio Sanchez Salazar, San Francisco, CA (US)

(21) Appl. No.: 19/363,577

(22) Filed: Oct. 20, 2025

Related U.S. Application Data
(60) Provisional application No. 63/709,291, filed on Oct. 18, 2024.

(51) Int. Cl. G06N 3/0455; G10L 13/00

(52) U.S. Cl. CPC G06N 3/0455; G10L 13/00

(57) ABSTRACT

Methods, systems, and apparatus, including computer programs encoded on computer storage media, for auto-regressively generating outputs using a decoder neural network that makes use of relative cross-attention.

### CROSS-REFERENCE TO RELATED APPLICATION

This application claims priority to U.S. Provisional Application No. 63/709,291, filed on Oct. 18, 2024. The disclosure of the prior application is considered part of and is incorporated by reference in the disclosure of this application.

### BACKGROUND

This specification relates to processing data using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers in one or more locations that performs a machine learning task on a conditioning input to auto-regressively generate an output conditioned on the conditioning input.

More specifically, the system performs auto-regressive generation using a decoder neural network that includes one or more relative cross-attention layer blocks that each have one or more cross-attention heads. Each of the cross-attention heads of any given relative cross-attention layer block performs cross-attention that uses a predicted alignment for the current decoder output being generated in order to incorporate relative position biases into the cross-attention mechanism.

Particular embodiments of the subject matter described in this specification can be implemented so as to realize one or more of the following advantages.

Autoregressive (AR) Transformer-based sequence models are known to, after training, have issues generalizing to sequences longer than those seen during the training. As a result of this, at inference-time, the models can perform poorly when required to generate long sequences. For example, for text-to-speech (TTS), these models tend to drop or repeat words or produce erratic output, especially for longer utterances.

This specification describes techniques that account for this and improve the robustness and length generalization issues encountered by conventional models. In particular, the techniques described in this specification enhance the decoder neural network used by an AR sequence model to address these robustness and length generalization issues.

More specifically, the described techniques use an alignment mechanism to provide cross-attention operations within the decoder with relative location information, improving the performance of the system after training, particularly when dealing with sequences that are a different length than, e.g., significantly longer than, the sequences that were included in the training data. Moreover, the associated alignment position is learned as a latent property of the model during training and requires no external alignment information during training. More generally, the described approach can leverage the monotonic nature of input-output alignment, e.g., TTS input-output alignment, while still benefitting from the flexible modeling power of interleaved multi-head self and cross-attention operations, resulting in significant improvement in inference performance.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example sequence generation system.

FIG. 2A shows an example of the architecture of the system when the system is configured to perform a TTS task.

FIG. 2B shows an example of the architecture of the decoder neural network

FIG. 3 is a flow diagram of an example process for generating an output from a conditioning input.

FIG. 4 is a flow diagram of an example process for generating a decoder output at a given decoder step.

FIG. 5 is a flow diagram of an example process for applying cross-attention using the respective relative position bias values.

FIG. 6 shows an example of the operations performed by the alignment block to generate the predicted alignment position.

Like reference numbers and designations in the various drawings indicate like elements.

### DETAILED DESCRIPTION

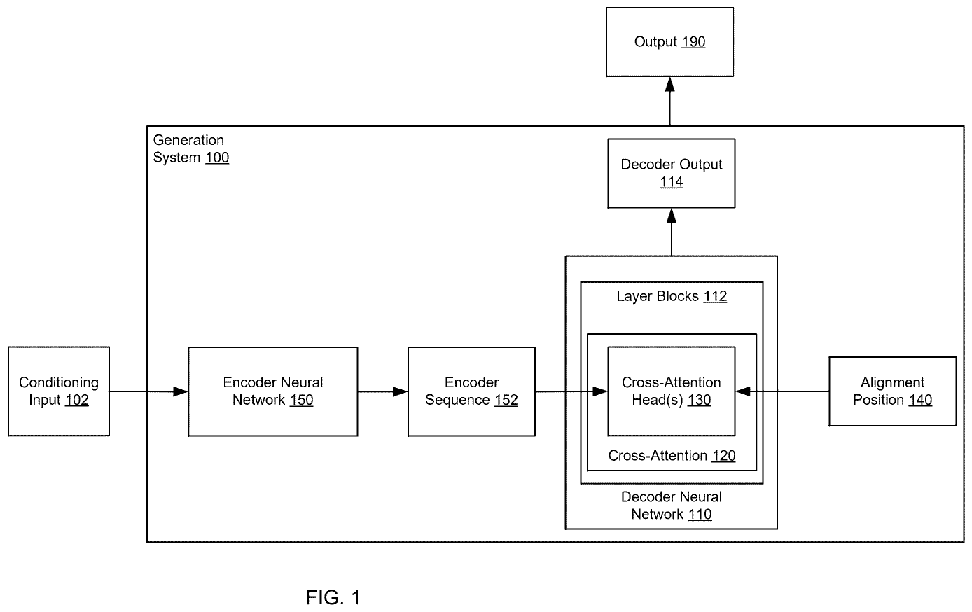

FIG. 1 shows an example sequence generation system 100. The sequence generation system 100 is an example of a system implemented as computer programs on one or more computers in one or more locations, in which the systems, components, and techniques described below can be implemented.

The system 100 performs a machine learning task on a conditioning input 102 to auto-regressively generate an output 190 conditioned on the conditioning input 102.

The machine learning task can generally be any appropriate task that requires generating an output 190 from a conditioning input 102.

As a particular example, the task can be a text-to-speech (TTS) task.

In particular, for the TTS task, the system 100 receives a conditioning input 102 that includes text in a natural language and generates, as the output 190, audio data that defines the text being spoken in the natural language. For example, the audio data can be a spectrogram, a waveform, or other data defining audio of the text being spoken.

The conditioning input 102 can optionally also include other information, e.g., speaker data, e.g., a speaker embedding, characterizing a target speaker for the speech.

As another example, the task can be a speech recognition task, where the conditioning input 102 includes speech data and the output 190 is text that is a transcript of the spoken speech.

As another example, the task can be a video or audio understanding task, where the conditioning input 102 includes video or audio data and the output 190 is a response, e.g., a natural language response or a structured response, to a query about the video or audio data.

More specifically, as part of generating the output 190, the system 100 performs auto-regressive generation using an encoder neural network 150 and a decoder neural network 110.

The encoder neural network 150 is configured to process the conditioning input 102 to generate an encoder output sequence 152 that includes a respective encoder output at each of a plurality of encoder positions. The respective encoder outputs are generally vectors or other ordered collections of numerical values, e.g., floating point values or other numerical values.

The encoder neural network 150 can generally have any appropriate architecture that allows the encoder neural network 150 to map the conditioning input 102 to a sequence of encoder outputs. For example, the encoder neural network 150 can be a self-attention neural network, a recurrent neural network, a convolutional neural network, or a neural network that has two or more of recurrent neural network layers, self-attention layers, or convolutional layers.

After the encoder neural network 150 has generated the encoder output sequence 152, the system uses the decoder neural network 110 to auto-regressively generate multiple decoder outputs 114.

The generation is referred to as being “auto-regressive” because the system 100 generates the respective decoder outputs 114 one after the other, i.e., generates one or more decoder outputs 114 at each of multiple decoder steps, with the generation of any given decoder output 114 being conditioned on the encoder output sequence 152 and on any decoder outputs 114 generated at any earlier decoder steps.

In some implementations, the respective decoder outputs 114 are the output 190 of the system 100. For example, the output 190 can be a sequence of the decoder outputs 114. As a particular example, when the output 190 is a sequence of text, the decoder outputs 114 can be text tokens, e.g., characters, subwords, words, or other units of text, to be included in the output text sequence.

In some other implementations, the system 100 further processes some or all of the decoder outputs 114 to generate the output 190.

For example, the decoder outputs 114 can be or can include discrete tokens representing a final network output for the conditioning input 102 and the system 100 can process the decoder outputs 114 using a discrete token decoder neural network to generate an initial network output for the conditioning input 102. The discrete token decoder neural network is a neural network that has been trained to map an input of discrete tokens to an output in a continuous space. For example, the discrete token decoder neural network can be have been trained jointly with an encoder neural network that maps inputs from the continuous space to discrete tokens representing the inputs. As a particular example, the discrete token encoder and the discrete token decoder can have been trained on any appropriate objective, e.g., a VQ-VAE or VQGAN objective or other vector quantization objective that both trains the encoder and decoder and learns a codebook of discrete tokens.

The system 100 can then use the initial network output as the output 190 or can process the initial network output to generate the final network output 190.

For example, when the output 190 is a TTS output, the decoder outputs 190 can represent audio data. For example, the decoder outputs 190 can be discrete tokens that represent audio and that can be decoded into a spectrogram, e.g., a mel spectrogram, by a discrete token decoder that has been trained as a decoder of a neural audio codec.

The system 100 can then process the spectrogram using a vocoder, e.g., a neural network-based vocoder or a statistical vocoder, to generate the audio that serves as the output 190.

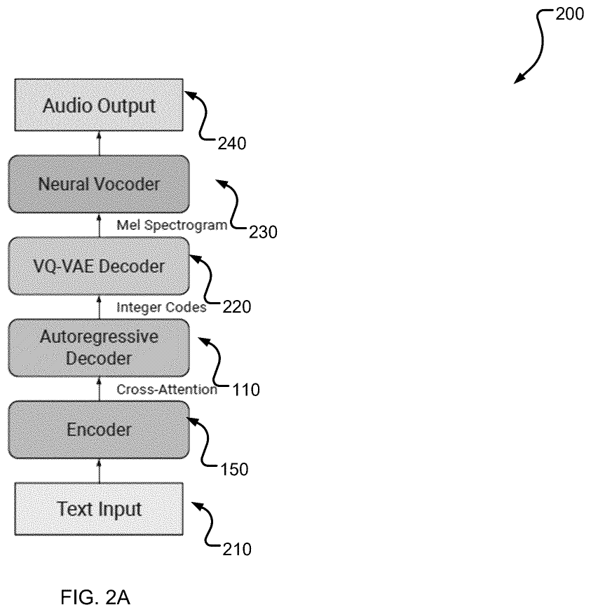

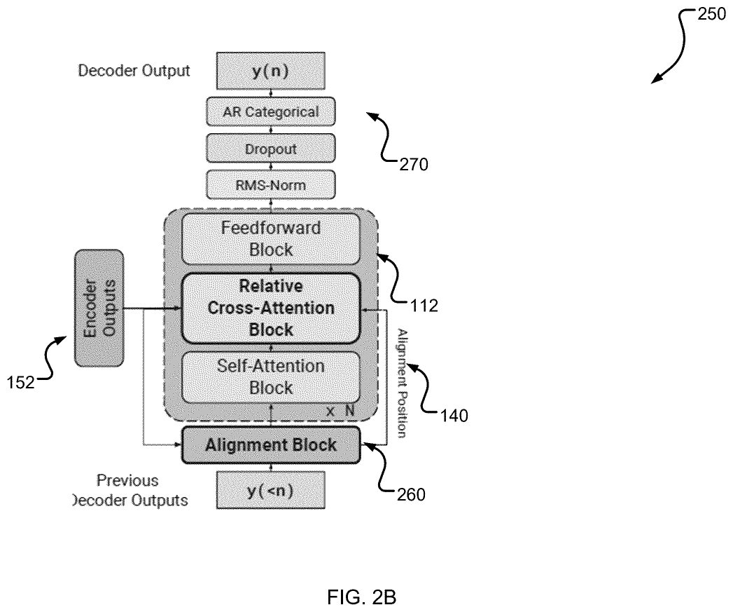

An example of this is described below with reference to FIG. 2A.

The decoder neural network 150 includes one or more decoder layer blocks 114. Thus, to generate any given decoder output, the decoder neural network 150 processes a representation of the decoder output at the preceding position through the one or more decoder layer blocks 114 and then through one or more output layers to generate the decoder output. For example, the decoder neural network 150 can process the representation through the decoder layer blocks 114 and then the output layers(s) to generate a respective score, e.g., a probability or a logit, for each token in a discrete set of tokens and can then select, as the decoder output, one of the discrete tokens using the respective scores.

To allow the decoder neural network 110 to condition the generation of the decoder outputs on the encoder output sequence 152, one or more of the decoder layer blocks 112 include a relative cross-attention layer block 120 that has one or more cross-attention heads 130.

Each of the cross-attention heads 130 of any given relative cross-attention layer block 120 performs cross-attention that uses a predicted alignment 140 for the decoder output that is being generated at the current decoder step in order to incorporate relative position biases into the cross-attention mechanism.

That is, in cross-attention, the queries are derived from the decoder output and the keys and values are derived from the encoder outputs, meaning that no positional correspondence between queries and key-values is available, i.e., because no information about which decoder output should correspond to which encoder output(s) is provided to the system 100.

Rather than performing cross-attention that does not incorporate positional information due to this lack of positional correspondence, the system 100 instead predicts an alignment position 140 for the decoder output. The alignment position 140 specifies a predicted position within the encoder outputs to which the given decoder output corresponds. The system 100 uses the predicted alignment position 140 for the given decoder output to determine relative position biases that the system 100 incorporates into the cross-attention mechanism.

As a result, the system 100 can more effectively incorporate context from the encoder outputs when generating the decoder outputs, resulting in a more accurate final output 190.

The decoder layer blocks 112 can also include other types of layers, e.g., self-attention layers, feed-forward layers, normalization layers, skip connection layers, and so on.

Relative cross-attention is described in more detail below.

FIG. 2A shows an example 200 of the architecture of the system 100 when the system 100 is configured to perform a TTS task.

As shown in the example 200, the system 100 receives a conditioning input that includes a text input 210. The system 100 processes the text input 210 using the encoder neural network 150 to generate an encoder output sequence that includes a respective encoder output at each of a plurality of encoder positions. For example, in this example, each respective encoder output can correspond to one or more of the text tokens in the text input 210.

The system 100 then generates a sequence of decoder outputs conditioned on the encoder output sequence using the auto-regressive decoder neural network 110. As described above, the decoder neural network 110 implements relative position cross-attention as part of generating any given decoder output. In the example 200, the decoder outputs are integer codes that identify discrete audio tokens that represent the final audio output.

The system 100 processes the decoder outputs using a discrete token decoder 220 to generate a mel spectrogram of the final audio. In the example 200, the discrete token decoder is a vector quantization variational autoencoder (VQVAE) decoder that maps discrete audio tokens to the mel spectrogram and that has been trained jointly with an encoder neural network to reconstruct input audio using a vector quantization training technique.

The system 100 then processes the mel spectrogram using a neural vocoder 230 to generate an audio output 240, e.g., a waveform, that represents speech of the text input 210 being spoken.

FIG. 2B shows an example 250 of the architecture of the decoder neural network 110.

As shown in the example 250, the decoder neural network 110 include an alignment block 260 that generates the predicted alignment 140, a sequence of N decoder layer blocks 112, and an output subnetwork 270.

When generating any given decoder output y at decoder step n, the decoder neural network 110 receives a representation of the previous decoder output at the preceding decoder step and processes the previous decoder output using the alignment block 260 to generate the predicted alignment position 140 for the given decoder output at decoder step n. As shown in the example 250, the alignment block 260 also updates the representation of the previous decoder output. Generally, the alignment block 260 determines the predicted alignment position 140 through a set of learned operations that are learned during the training of the decoder neural network 150.

The system 100 then processes the representation of the previous decoder output, the predicted alignment position 140, and the encoder outputs 270 generated by the encoder neural network 150 through the sequence of decoder layer blocks 112 to generate an updated representation.

The system 100 then processes the output of the sequence of decoder layer blocks 112, i.e., the updated representation, using the output subnetwork 270 to generate the decoder output y (n) at decoder step n. In the example 250, the output subnetwork 270 includes a normalization layer, i.e., an RMS-Norm layer, a dropout layer, and an auto-regressive categorical layer that generates a categorical distribution over the discrete set of discrete tokens.

More specifically, the categorical layer is referred as auto-regressive because, at each generation step, the decoder generates a sequence of multiple discrete latent codes that represent a frame of the initial network outputs. The auto-regressive categorical layer models the joint distribution of the discrete latent codes contained in one frame using an auto-regressive decomposition.

That is, each decoder output can be a single discrete latent token or, as in the example of FIG. 2B, can be a frame of multiple discrete latent tokens.

Each of the decoder layer blocks 112 includes a self-attention block, followed by a cross-attention block, and followed by a feedforward block.

The self-attention block includes one or more self-attention heads.

Each self-attention head is configured to receive an input representation of the decoder output at the decoder step and apply a self-attention mechanism over respective input representations of the decoder output at the decoder step and decoder outputs generated at any preceding steps to generate an output representation of the decoder output at the decoder step. For example, the self-attention mechanism can use relative position biases. Unlike for cross-attention, because the self-attention mechanism is applied within the same sequence, the distances needed to compute the relative position biases are naively available for use in the computation.

When the set of one or more self-attention heads includes a plurality of self-attention heads, the self-attention block is configured to combine the output representations generated by the plurality of self-attention heads to generate an output of the self-attention block. For example, the self-attention block can concatenate the output representations and, optionally, apply a learned linear projection to generate the output.

The cross-attention block performs relative cross-attention that leverages the encoder outputs 270 and the predicted alignment position 140 for the given decoder output to update the representation of the preceding decoder output.

Performing relative cross-attention and generating the predicted alignment position are described in more detail below.

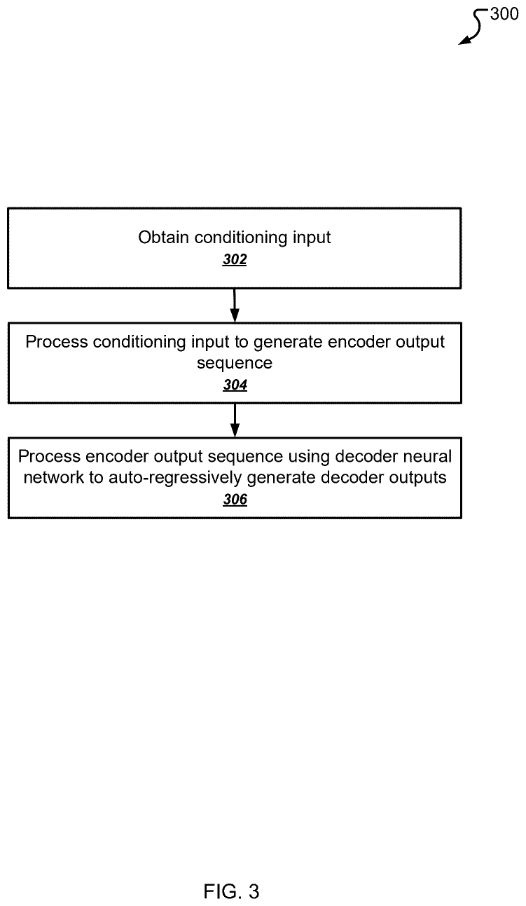

FIG. 3 is a flow diagram of an example process 300 for generating an output from a conditioning input. For convenience, the process 300 will be described as being performed by a system of one or more computers located in one or more locations. For example, a sequence generation system, e.g., the sequence generation system 100 depicted in FIG. 1, appropriately programmed in accordance with this specification, can perform the process 300.

The system obtains a conditioning input (step 302).

The system processes the conditioning input using an encoder neural network to generate an encoder output sequence that includes a respective encoder output at each of a plurality of encoder positions (step 304). Each encoder output can be, e.g., an embedding, i.e., an ordered collection of numerical values, e.g., a vector, having a specified dimensionality.

The system processes a decoder input that includes the conditioning input using a decoder neural network to auto-regressively generate an output that includes multiple decoder outputs (step 306). The generation is referred to as “auto-regressive” because the system generates a respective set of one or more decoder outputs at each of multiple decoder steps, with the decoder output at any given decoder step being conditioned on the conditioning input and the decoder outputs generated at any preceding steps.

Generating the output at a given decoder step is described in more detail below. As described above, in some cases, the decoder generates the final outputs of the system, i.e., the decoder outputs are the final outputs of the system. In other cases, the system further processes the decoder outputs to generate the final outputs.

For example, the decoder outputs can be discrete tokens representing a final network output for the conditioning input. That is, each decoder output can be a single discrete token or each decoder output can be a frame or other set of multiple discrete tokens.

In this example, the system can process the decoder outputs using a discrete token decoder to generate an initial network output for the conditioning input. The system can then process the initial network output to generate the final network output. As a particular example, of this, the initial network output can be a spectrogram and the final network output is an audio waveform.

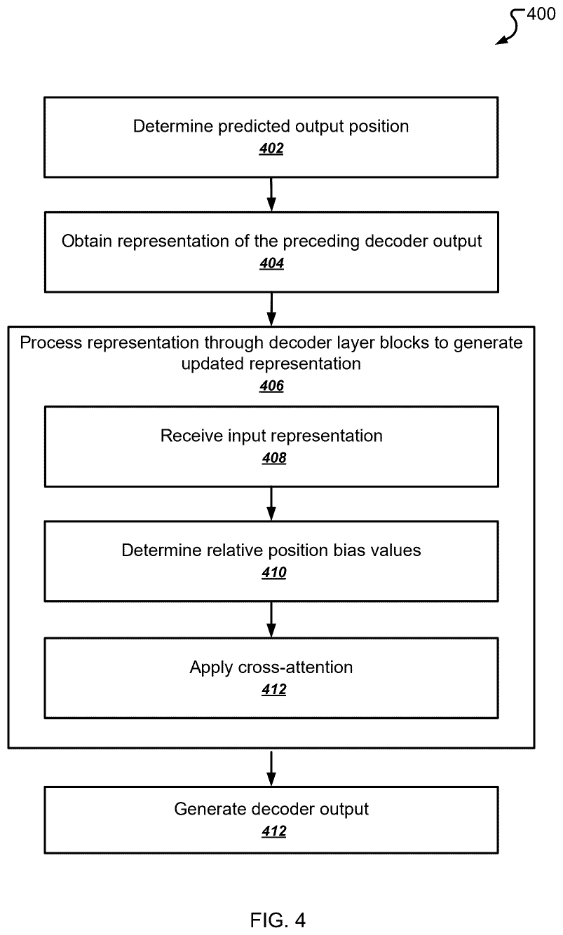

FIG. 4 is a flow diagram of an example process 400 for generating a decoder output at a given decoder step. For convenience, the process 400 will be described as being performed by a system of one or more computers located in one or more locations. For example, a sequence generation system, e.g., the sequence generation system 100 depicted in FIG. 1, appropriately programmed in accordance with this specification, can perform the process 200.

The system determines a predicted alignment position within the encoder output sequence of the respective decoder output at the decoder step (step 402). That is, the system predicts a position within the encoder output that corresponds to the decoder output being generated at the decoder step.

Generally, the system determines the predicted alignment position through a set of learned operations that are learned during the training of the decoder neural network.

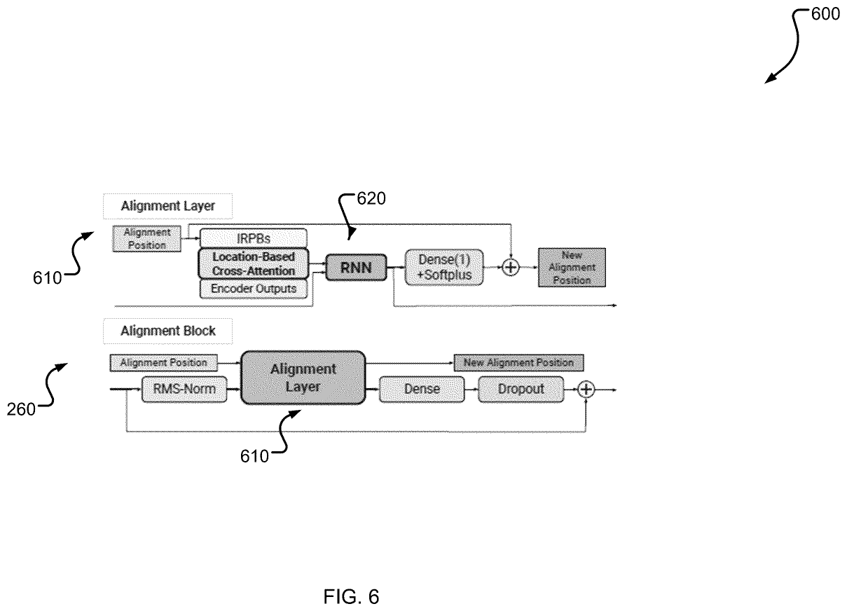

For example, as described above, the system can determine the predicted alignment position using an alignment block as described above. An example of the operations performed by the alignment block is described below with reference to FIG. 6.

The system obtains a representation of the decoder output at the decoder step (step 404). For example, the representation can be an embedding of the decoder output or an updated representation of the decoder output generated from the embedding of the decoder output by the alignment block, as described above and in more detail below.

The system processes the representation of the decoder output at the decoder step through one or more decoder layer blocks to generate an updated representation of the decoder output at the decoder step (step 406). That is, the input to the first decoder layer block is the representation of the decoder output and the input to any subsequent decoder layer block is the representation after being updated by the preceding decoder layer block.

As described above, one or more of the decoder layer blocks includes a relative cross-attention block.

Each relative-cross attention block includes a set of one or more cross-attention heads that are each configured to, as part of the processing of the representation of the decoder output, receive an input representation of the decoder output at the decoder step (step 408).

Each cross-attention head determines, for each of the encoder outputs, a respective relative position bias value based on (i) the predicted alignment position within the encoder output sequence of the respective decoder output at the decoder step and (ii) the respective encoder position of the encoder output (step 410). That is, even though the decoder output has no known position within the encoder output sequence, the system nonetheless uses the predicted alignment position that was predicted for the decoder output to determine the relative position bias value.

For example, to determine the bias value for a given encoder output, the cross-attention head can determine a difference between: (i) a value derived from the predicted alignment position within the encoder output sequence of the respective decoder output at the decoder step and (ii) a value derived from the respective encoder position of the encoder output.

For example, the value derived from the predicted alignment position can be equal to the predicted alignment position or can be the output of a function applied to the predicted alignment position.

Similarly, the value derived from the respective encoder position of the encoder output can be equal to the respective encoder position or can be the output of the function applied to the respective encoder position of the encoder output.

The system can then determine the respective relative position bias value for the encoder output based on the difference.

For example, the system can maintain, for each cross-attention head of each cross-attention layer block, a respective bias value for each output in the range of a bias function. Generally, the respective bias values can be learned during the training of the decoder neural network.

Then, to determine the respective relative position bias value for the encoder output based on the difference, the system can determine an output of the bias function applied to the distance.

For example, the bias function ƒ can map distances d to outputs as follows:

$$f ( d ) = \{ \begin{matrix}d , & d ∈ [ 0 , B / 2 ) \\ B / 2 + \frac{log ( \frac{d}{B / 2} )}{log ( \frac{D}{B / 2} )} ( B / 2 - 1 ) , & d ∈ [ B / 2 , D ) \\ B - 1 , & d \geq D \\ - f ( - d ) , & d < 0\end{matrix}$$

where B and D are constant values. For example, B can be one of 8, 16, 24, or 32 and D can be one of 24, 32, 64, or 128.

Any other appropriate bias function that maps relative distances to multiple different bucketed outputs can also be used.

The system can then assign, as the relative position bias value for the encoder output, the respective bias value for the output ƒ(d) of the bias function ƒ applied to the distance d.

For example, the system can translate the output of the bias function into a bias value by linearly interpolating between the two bias values at the adjacent integer indices in the bias matrix of the learned bias values for the cross-attention head. For example, given an output n of the bias function, the bias value for attention head k can be equal to:

$${b}_{⌊ η ⌋ 0}^{( k )} + ( \vert η \vert - ⌊ \vert η \vert ⌋ ) ( {b}_{⌊ η ⌋ 0}^{( k )} - {b}_{⌊ η ⌋ 0}^{( k )} ) ,$$

where ┌x┐₀:=sgn(x)┌|x|┐ rounds away from zero and └x┘₀:=sgu(x)└|x|┘ rounds toward zero and the b^{(k)} represent corresponding learned bias values for the attention head k.

Thus, the respective relative position bias values are differentiable with respect to the predicted alignment position, allowing for the components that generate the predicted alignment position to be learned jointly during the training of the decoder neural network.

Each cross-attention head then applies cross-attention between the input representation of the decoder output and the encoder outputs using the respective relative position bias values for the encoder outputs to generate an output representation of the decoder output (step 412).

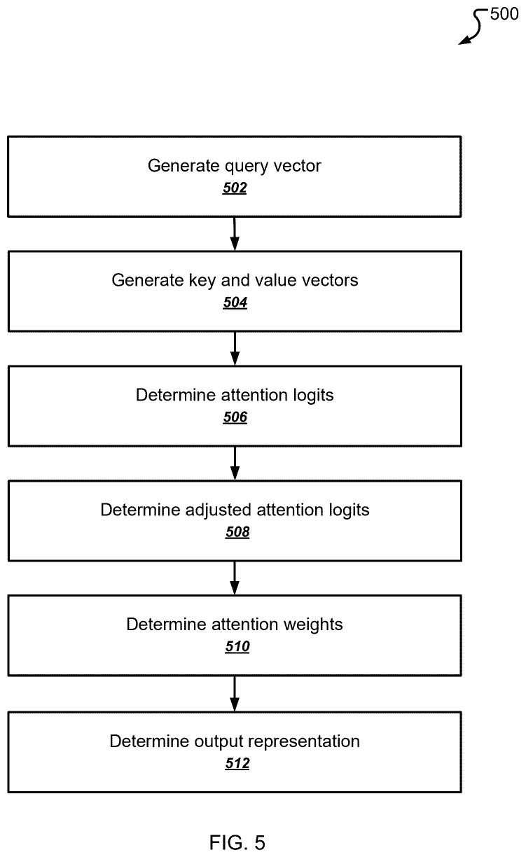

Applying cross-attention using relative position bias values will be described below with reference to FIG. 5.

When there are multiple cross-attention heads, the cross-attention layer block then combines the output representations generated by the heads to generate the final output of the cross-attention layer block. For example, the cross-attention layer block can concatenate the output representations and then, optionally, apply one or more learned transformations to the concatenated output representations.

The system then processes the updated representation of the decoder output at the decoder step to generate the decoder output at the decoder step (step 414). For example, the system can process the updated representation using one or more output layers as described above to generate the decoder output.

FIG. 5 is a flow diagram of an example process 500 for applying cross-attention using the respective relative position bias values. For convenience, the process 500 will be described as being performed by a system of one or more computers located in one or more locations. For example, a sequence generation system, e.g., the sequence generation system 100 depicted in FIG. 1, appropriately programmed in accordance with this specification, can perform the process 500.

The system generates a query vector from the input representation of the decoder output (step 502). For example, the system can use the input representation as the query vector or can apply a learned transformation, e.g., a learned linear transformation, to the input representation to generate the query vector.

The system generates a respective key vector and a respective value vector for each of the encoder outputs (step 504). For example, the system can use the encoder outputs as the key and value vectors or can apply respective learned transformations, e.g., learned linear transformations, to each encoder output to generate the key and value vectors for the encoder output.

The system determines a respective attention logit for each of the encoder outputs from the query vector and the respective key vector for the encoder output (step 506). For example, the system can compute, for each encoder output, a dot product between the query vector and the respective key vector for the encoder output and then optionally divide the dot product by a normalization factor, e.g., that is equal to the square root of the length of the query vector.

The system then determines a respective adjusted attention logit for each of the encoder outputs from the respective attention logit for the encoder output and the respective relative position bias value for the encoder output (step 508). For example, the system can add the respective relative position bias value to the encoder output from the respective attention logit for the encoder output.

In this example, the adjusted attention logit

$$\text{?}$$

$$\text{?} \text{indicates text missing or illegible when filed}$$

for the encoder output at position j for attention head k satisfies:

$${s}_{i , j}^{( k )} = \frac{{q}_{i}^{( k )} \cdot {k}_{j}^{( k )}}{\sqrt{L}} + {β}^{( k )} ( {p}_{i} - j ) ,$$

where L is the length of the query vector, β^{(k)}(pᵢ−j) is the respective relative position bias value for the encoder output at position j,

$$\text{?}$$

$$\text{?} \text{indicates text missing or illegible when filed}$$

is the query vector, and

$$\text{?}$$

$$\text{?} \text{indicates text missing or illegible when filed}$$

is the key vector for the encoder output at position j.

The system determines a respective attention weight for each of the encoder outputs from the respective adjusted attention logits for the encoder outputs (step 510). For example, the system can determine the attention weights by applying a softmax function to the respective adjusted attention logits.

The system determines the output representation of the decoder output by determining a weighted sum of the respective value vectors for the encoder outputs in accordance with the respective attention weights for the encoder outputs (step 512). That is, in the weighted sum, the weight for the value vector for a given encoder output is equal to the respective attention weight for the encoder output.

FIG. 6 shows an example 600 of the operations performed by the alignment block 260 to generate the predicted alignment position.

Generally, the alignment block 260 determines the predicted alignment position conditioned on respective decoder outputs at any preceding decoder steps.

In the example of FIG. 6, the alignment block 260 processes the representation of the decoder output at the preceding decoder step using to generate an alignment layer block output that that includes the predicted alignment position. In the example of FIG. 6, the alignment block output also includes an updated representation of the decoder output that is provided to layer blocks 112, i.e., as the input representation for the first decoder layer block 112.

In the particular example, of FIG. 6, the alignment block 260 determines the predicted alignment position conditioned on (i) respective decoder outputs at any preceding decoder steps and (ii) the encoder outputs.

More specifically, the alignment block includes an alignment layer 610.

The alignment layer 610 processes a recurrent input that includes the decoder output at the preceding decoder step using a recurrent neural network 620 to generate a recurrent output and then processes the recurrent output to generate the predicted alignment position. For example, to maintain computational efficiency, the recurrent neural network 620 can be a single recurrent layer, e.g., a single long short-term memory (LSTM) layer or gated recurrent unit (GRU) layer.

In the example 600, the alignment layer 610 processes the recurrent output by applying a linear layer followed by a softplus function to the recurrent output to generate an initial predicted alignment position and then combines, e.g., sums, the initial predicted alignment position with a predicted alignment position for the decoder output at the preceding decoder step to generate the predicted alignment position for the output token at the decoder step. This ensures that the alignment position is monotonically advancing, i.e., does not decrease between one decoder output and the next decoder output.

As shown in the example 600, the recurrent input also includes an attention context vector generated from the encoder outputs to provide the recurrent neural network 620 with information about where the predicted alignment position the decoder output at the preceding decoder step falls within the encoder outputs.

To generate the attention context vector, the system generates an initial attention context vector for each of one or more cross-attention heads.

Each cross-attention head generates a respective attention weight for each of the encoder outputs from (i) a predicted alignment position the decoder output at the preceding decoder step and (ii) the respective encoder position of the encoder output. For example, the system can determine, for each encoder output, a respective interpolated relative position bias (IRPB) from the distance between the predicted alignment position the decoder output at the preceding decoder step and (ii) the respective encoder position of the encoder output, e.g., as described above. That is, the system can compute the bias values as described above with reference to the bias values used by the cross-attention heads.

The system can then apply a softmax function or a scaled softmax function to the respective IRPBs to generate the attention weights. Thus, this is a purely location-based attention that does not rely on the content of the encoder outputs but only on their positions within the encoder sequence.

The system can then determine an initial attention context vector by determining a weighted sum of respective value vectors for the encoder outputs in accordance with the respective attention weights for the encoder outputs.

Thus, the cross-attention operation is a location-based cross-attention operation are produced using alignment-informed IRPBs and no content-based query-key comparisons.

The system can then combine the respective initial attention context vectors for the cross-attention heads to generate the final attention context vector.

As shown in the example 600, the block 260 also processes the recurrent output to generate the updated representation of the decoder output to generate the representation that is provided as input to the blocks 112. For example, in the example 600, the block 260 processes the recurrent output through a dense neural network layer optionally followed by a dropout operation to generate the updated representation that is provided as input to the blocks 112.

Prior to using the encoder neural network and the decoder neural network to generate outputs, the system 100 or another training system trains the encoder neural network and decoder neural network on a set of training data. The training data includes a set of training examples, with each training example including (i) a respective training conditioning input and (ii) a respective sequence of training decoder outputs for the training conditioning input. For example, the training decoder outputs can be a sequence of discrete latent codes that represent the final output for the respective training conditioning input.

The training objective for the training can generally be any appropriate training objective, e.g., a negative log-likelihood loss or a cross-entropy loss. As part of this training, the system learns the parameters required to generate the predicted alignment positions, i.e., learns the parameters of the alignment block, and the parameters of the cross-attention heads of the relative cross-attention block(s). That is, because the position biases are differentiable as described above, the system can backpropagate through these biases in order to update the parameters of the alignment block.

As described above, in some cases, the sequences training decoder outputs during training can generally be shorter than (some of) the outputs that the decoder is required to generate after training. However, because of the use of the relative cross-attention, the decoder can nonetheless accurately generate these longer sequences after training.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining a conditioning input:
processing the conditioning input using an encoder neural network to generate an encoder output sequence that comprises a respective encoder output at each of a plurality of encoder positions; and
processing a decoder input comprising the conditioning input using a decoder neural network to generate a respective decoder output at each of a plurality of decoder steps, comprising, at each of the plurality of decoder steps:
determining a predicted alignment position within the encoder output sequence of the respective decoder output at the decoder step;
obtaining a representation of the decoder output at the decoder step;
processing the representation of the decoder output at the decoder step through one or more decoder layer blocks to generate an updated representation of the decoder output at the decoder step, wherein one or more of the decoder layer blocks comprise a relative cross-attention block that comprises a set of one or more cross-attention heads that are each configured to:
receive an input representation of the decoder output at the decoder step;
determine, for each of the encoder outputs, a respective relative position bias value based on (i) the predicted alignment position within the encoder output sequence of the respective decoder output at the decoder step and (ii) the respective encoder position of the encoder output; and
apply cross-attention between the input representation of the decoder output and the encoder outputs using the respective relative position bias values for the encoder outputs to generate an output representation of the decoder output; and
processing the updated representation of the decoder output at the decoder step to generate the decoder output at the decoder step.

2. The method of claim 1, wherein applying cross-attention between the input representation of the decoder output and the encoder outputs using the respective relative position bias values to generate an output representation of the decoder output comprises:
generating a query vector from the input representation of the decoder output;
generating a respective key vector and a respective value vector for each of the encoder outputs;
determining a respective attention logit for each of the encoder outputs from the query vector and the respective key vector for the encoder output;
determining a respective adjusted attention logit for each of the encoder outputs from the respective attention logit for the encoder output and the respective relative position bias value for the encoder output;
determining a respective attention weight for each of the encoder outputs from the respective adjusted attention logits for the encoder outputs; and
determining the output representation of the decoder output by determining a weighted sum of the respective value vectors for the encoder outputs in accordance with the respective attention weights for the encoder outputs.

3. The method of claim 2, wherein determining a respective adjusted attention logit for each of the encoder outputs from the respective attention logit for the encoder output and the respective relative position bias value for the encoder output comprises:
adding the respective relative position bias value for the encoder output to the respective attention logit for the encoder output.

4. The method of claim 2, wherein determining a respective attention weight for each of the encoder outputs from the respective adjusted attention logits for the encoder outputs comprises:
applying a softmax to the respective adjusted attention logits for the encoder outputs.

5. The method of claim 1, wherein determining, for each of the encoder outputs, a respective relative position bias value based on (i) the predicted alignment position within the encoder output sequence of the respective decoder output at the decoder step and (ii) the respective encoder position of the encoder output comprises:
determining a difference between:
(i) the predicted alignment position within the encoder output sequence of the respective decoder output at the decoder step and (ii) the respective encoder position of the encoder output or
(iii) an output of a first function applied to the predicted alignment position within the encoder output sequence of the respective decoder output at the decoder step and (iv) an output of the first function applied to the respective encoder position of the encoder output; and
determining the respective relative position bias value for the encoder output based on the difference.

6. The method of claim 5, further comprising:
maintaining, for each cross-attention head of each cross-attention layer block, a respective bias value for each output in a range of a bias function, and wherein determining the respective relative position bias value for the encoder output based on the difference comprises:
determining an output of the bias function applied to the distance; and
assigning, as the relative position bias value for the encoder output, the respective bias value for the output of the bias function applied to the distance.

7. The method of claim 6, wherein the respective bias values for the outputs in the range of the bias function are learned during training of the decoder neural network.

8. The method of claim 1, wherein the set of one or more cross-attention heads comprises a plurality of cross-attention heads and wherein the cross-attention block is configured to combine the output representations generated by the plurality of cross-attention heads to generate an output of the cross-attention block.

9. The method of claim 8, wherein combining the output representations generated by the plurality of cross-attention heads to generate an output of the cross-attention block comprises:
concatenating the output representations; and
applying one or more learned transformations to the concatenated output representations.

10. The method of claim 1, wherein one or more of the decoder layer blocks comprise a self-attention block that comprises a set of one or more self-attention heads that are each configured to:
receive an input representation of the decoder output at the decoder step; and
apply a self-attention mechanism over respective input representations of the decoder output at the decoder step and decoder outputs generated at any preceding steps to generate an output representation of the decoder output at the decoder step.

11. The method of claim 1, wherein determining the predicted alignment position conditioned on respective decoder outputs at any preceding decoder steps comprises:
determining the predicted alignment position conditioned on (i) respective decoder outputs at any preceding decoder steps and (ii) the encoder outputs.

12. The method of claim 1, wherein determining the predicted alignment position comprises:
processing an input representation of the decoder output at the preceding decoder step using an alignment layer block to generate an alignment layer block output that comprises the predicted alignment position.

13. The method of claim 12, wherein the alignment layer block output further comprises the representation of the decoder output at the decoder step.

14. The method of claim 13, wherein processing the input representation of the decoder output at the preceding decoder step using an alignment layer block to generate an alignment layer block output that comprises the predicted alignment position comprises:
processing a recurrent input comprising the decoder output at the preceding decoder step using a recurrent neural network to generate a recurrent output; and
processing the recurrent output to generate the predicted alignment position.

15. The method of claim 1, further comprising:
processing the decoder outputs using a discrete token decoder to generate an initial network output for the conditioning input.

16. The method of claim 15, further comprising:
processing the initial network output to generate the final network output.

17. The method of claim 16, wherein the initial network output is a spectrogram and wherein the final network output is an audio waveform.

18. The method of claim 1, wherein determining a predicted alignment position within the encoder output sequence of the respective decoder output at the decoder step comprises:
determining the predicted alignment position through a set of learned operations that are learned during the training of the decoder neural network.

19. One or more non-transitory computer storage media storing instructions that when executed by one or more computers cause the one or more computers to perform operations comprising:
obtaining a conditioning input:
processing the conditioning input using an encoder neural network to generate an encoder output sequence that comprises a respective encoder output at each of a plurality of encoder positions; and
processing a decoder input comprising the conditioning input using a decoder neural network to generate a respective decoder output at each of a plurality of decoder steps, comprising, at each of the plurality of decoder steps:
determining a predicted alignment position within the encoder output sequence of the respective decoder output at the decoder step;
obtaining a representation of the decoder output at the decoder step;
processing the representation of the decoder output at the decoder step through one or more decoder layer blocks to generate an updated representation of the decoder output at the decoder step, wherein one or more of the decoder layer blocks comprise a relative cross-attention block that comprises a set of one or more cross-attention heads that are each configured to:
receive an input representation of the decoder output at the decoder step;
determine, for each of the encoder outputs, a respective relative position bias value based on (i) the predicted alignment position within the encoder output sequence of the respective decoder output at the decoder step and (ii) the respective encoder position of the encoder output; and
apply cross-attention between the input representation of the decoder output and the encoder outputs using the respective relative position bias values for the encoder outputs to generate an output representation of the decoder output; and
processing the updated representation of the decoder output at the decoder step to generate the decoder output at the decoder step.

20. A system comprising one or more computers and one or more storage devices storing instructions that when executed by the one or more computers cause the one or more computers to perform operations comprising:
obtaining a conditioning input:
processing the conditioning input using an encoder neural network to generate an encoder output sequence that comprises a respective encoder output at each of a plurality of encoder positions; and
processing a decoder input comprising the conditioning input using a decoder neural network to generate a respective decoder output at each of a plurality of decoder steps, comprising, at each of the plurality of decoder steps:
determining a predicted alignment position within the encoder output sequence of the respective decoder output at the decoder step;
obtaining a representation of the decoder output at the decoder step;
processing the representation of the decoder output at the decoder step through one or more decoder layer blocks to generate an updated representation of the decoder output at the decoder step, wherein one or more of the decoder layer blocks comprise a relative cross-attention block that comprises a set of one or more cross-attention heads that are each configured to:
receive an input representation of the decoder output at the decoder step;
determine, for each of the encoder outputs, a respective relative position bias value based on (i) the predicted alignment position within the encoder output sequence of the respective decoder output at the decoder step and (ii) the respective encoder position of the encoder output; and
apply cross-attention between the input representation of the decoder output and the encoder outputs using the respective relative position bias values for the encoder outputs to generate an output representation of the decoder output; and
processing the updated representation of the decoder output at the decoder step to generate the decoder output at the decoder step.
